(19) United States
(12) Patent Application Publication
(10) Pub. No.: US 2009/0246670 A1
(43) Pub. Date: Oct. 1, 2009

(54) CARRIER PARTICLES FOR FORMING WIRING CIRCUIT PATTERN AND DEVELOPER

(75) Inventors: Koji AGA, Kashiwa-shi (JP); Atsushi NII, Kashiwa-shi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/399,217

(22) Filed: Mar. 6, 2009

(30) Foreign Application Priority Data
Mar. 31, 2008 (JP) 2008-090670

(51) Int. Cl. G03G 9/113; G03G 9/107; G03G 9/08

(52) U.S. Cl. 430/108.6; 430/111.1; 430/111.32; 430/110.4; 430/108.1; 430/108.7

(57) ABSTRACT

Carrier particles for forming a wiring circuit pattern by an electrophotographic developing method which are used for directly forming a circuit shape on an insulating layer, with any of a metal powder, an inorganic compound powder, or a mixed raw material powder thereof used as a toner powder for forming a circuit, the toner powder for forming a circuit being adhered to a surface of the carrier particles by electrostatic force and then transported to a surface of the insulating layer, wherein the carrier particles include a resin coated layer of an acrylic resin composition containing an amino-group-containing polymer on the surface of the carrier core material particles, the coating amount of the acrylic resin composition is 0.3 to 3.0% by weight based on a carrier core material weight of 100% by weight, and a shape factor SF-1 of the carrier core material particles is 100 to 110.

### BACKGROUND OF THE INVENTION

1. Field of the Invention

The present invention relates to carrier particles for forming a wiring circuit pattern which have high charge properties and excellent charge startup properties and fluidity, and which can impart a good charge to a toner, and a developer for forming a wiring circuit pattern using these carrier particles.

2. Description of the Related Art

Conventionally, screen printing has been employed for the formation of conductive patterns and the like. However, since screen printing uses a screen formed from a mesh-like net, the printing precision deteriorates due to the screen sagging from being used over time. Further, a plate making is needed for each circuit pattern. Thus, there are drawbacks in terms of production efficiency and costs.

As a printing method which replaces screen printing, printing by an electrophotographic system using a developer composed of a toner and a carrier has become common. Printing by an electrophotographic system applies electrophotographic technology, and application in which printing is performed onto media other than paper is expanding. Examples of such applications include wiring pattern formation by a conductive substance on a circuit board, and a formation of an insulating resin layer on a circuit pattern.

Since in such applications special materials are included more often than in toners for normal printing, in many cases a charge control agent cannot be used, or even if a charge control agent can be used, there are limitations on the added amount, so that it is currently difficult to frictionally charge the toner.

Further, since the printed layer needs to have a certain thickness compared with the target on which printing is carried out, the toner is characterized by having a particle size which is larger than that of a toner for conventional printing.

Conventional charging from the friction between a carrier and a toner is presumed on the fact that the toner is sufficiently small with respect to the carrier surface, so that the presence of indents on the carrier surface has not been much of a problem. However, as described above, if the toner has a bumpy size much larger than that of typical toners, the indents on the carrier surface, which conventionally have not been a problem, can hinder frictional charging. Specifically, if the particle size of the toner and the carrier is close, although it is possible for the toner and the carrier to come into point contact with each other, in reality there are indents on both the carrier surface and the toner surface, and if the level of those indents is about the same, then since the level of point contacts between the toner and the carrier decreases, sufficient charging does not occur.

Further, due to toner material limitations, conventional carriers which do not easily charge a toner have the problem that they cannot impart a sufficient charge to the toner.

Further, since there is an assumption for high printing rate used at about the same level as conventional full color printers etc. which print on paper, good charge startup is required.

Various proposals have been made for formation of a conductive pattern and the like using such an electrophotographic method. Japanese Patent Laid-Open No. 11-193402 discloses insulating surface-treated metal particles which have an average particle size in the range of 2 to 20 μm which were provided with insulating properties by coating a thermoplastic insulating substance on the surface of metal particles. Such insulating surface-treated metal particles can realize both a large metal particle ratio and high insulating properties, and when utilized as a toner for forming a conductive pattern on a green sheet by electrophotography, a conductive pattern can be printed and formed with high precision since a uniform charge is possible due to the high insulating properties. Further, Japanese Patent Laid-Open No. 11-193402 describes that after sintering a conductive pattern can be formed which has good conduction and high reliability. Further, concerning the carrier, it is described that an iron powder carrier, a ferrite carrier or the like is used, and that the particle size is preferably 40 to 120 μm.

Japanese Patent Laid-Open No. 11-193402 enables uniform charge by using insulating surface-treated metal particles as the toner, but only contains a typical description regarding the carrier.

Japanese Patent Laid-Open No. 2003-345206 describes a method for forming a circuit pattern using a two-component developer composed of a carrier powder and a charged powder for forming a circuit. It is described that the carrier powder contains 50% by weight or more of one kind or more of a metal, an alloy, and a compound for forming a circuit, and that a carrier powder is used which has a surface covered with an insulating film. Japanese Patent Laid-Open No. 2003-345206 describes that this carrier powder includes a metal for forming a circuit composed of copper, nickel, chromium and the like, and that the surface of this metal for forming a circuit is coated with an insulating film composed of polystyrene, poly-p-chlorostyrene, polyvinyltoluene and the like.

Japanese Patent Laid-Open No. 2003-345206 discloses that by using such a carrier powder, an increase in the electrical resistivity of the pattern can be prevented even if the carrier powder is stuck to the circuit pattern. However, this carrier does not impart a good charge to the toner.

Japanese Patent No. 3994154 describes a two-component developer for forming a conductive pattern by electrophotography, in which the developer is composed of a specific metal toner and a carrier in which magnetic particles are coated by a resin layer (claim 7). Examples of the resin used in such carrier are mentioned as a fluorine resin, a silicone resin, and an acrylic resin, and the resin weight is described as 0.1 to 3% by weight of the magnetic body particles. The magnetic body particles are described as being formed from ferrite, magnetite, and iron, and the carrier average particle size is described as being 20 to 100 μm (claims 8 to 11).

In Japanese Patent No. 3994154, it is described that a conductive pattern can be printed and formed on a substrate or on a thin film sheet with high precision due to the fact that a high charge and a uniform charge are possible, so that after fixing a conductive pattern can be formed which has few pin holes, good conductivity, and high reliability, by a method for forming an electrophotographic image using a developer composed of a metal toner coated with a surface treating agent thin film layer and a carrier coated with a resin layer (paragraph [0048]).

Although this Japanese Patent No. 3994154 describes that the carrier imparts a good charge to the toner, a carrier which just coats a resin layer of a fluorine resin and the like on magnetic body particles cannot impart a sufficient charge to a toner. Further, such a carrier cannot achieve high charge properties and charge startup properties.

Thus, for developers for forming a wiring circuit pattern, carrier particles which impart a sufficient charge to a toner, and have a high charge, and yet have excellent charge startup properties, are yet to be obtained.

### SUMMARY OF THE INVENTION

Therefore, it is an object of the present invention to provide carrier particles for forming a wiring circuit pattern which have a high charge, excellent charge startup properties and fluidity, and which can impart a sufficient charge to a toner, and a developer using this carrier.

As a result of intensive investigation to resolve the above problems, the present inventors discovered that the above objects can be achieved by spherical carrier particles which have a carrier core material particle surface coated with a specific resin coated layer, thereby arriving at the present invention.

Specifically, the present invention provides carrier particles for forming a wiring circuit pattern by an electrophotographic developing method which are used for directly forming a circuit shape on an insulating layer, with any of a metal powder, an inorganic compound powder, or a mixed raw material powder thereof used as a toner powder for forming a circuit, the toner powder for forming a circuit being adhered to a surface of the carrier particles by electrostatic force and then transported to a surface of the insulating layer, wherein the carrier particles comprise a coated layer of an acrylic resin composition containing an amino-group-containing polymer on the surface of the carrier core material particles, the coating amount of the acrylic resin composition is 0.3 to 3.0% by weight based on a carrier core material weight of 100% by weight, and a shape factor SF-1 of the carrier core material particles is 100 to 110.

The carrier particles for forming a wiring circuit pattern according to the present invention preferably have a degree of fluidity of 20 to 60 sec/50 g.

In the carrier particles for forming a wiring circuit pattern according to the present invention, the carrier core material particles are preferably formed from a ferrite component.

The carrier particles for forming a wiring circuit pattern according to the present invention preferably have an average particle size D₅₀ (c) of 20 to 200 μm.

The carrier particles for forming a wiring circuit pattern according to the present invention preferably have a resistivity of 5×10⁸ Ω to 1×10¹³ Ω.

In the carrier particles for forming a wiring circuit pattern according to the present invention, the coated layer is preferably formed by a fluidized bed coater.

Further, the present invention provides a developer for forming a wiring circuit pattern comprising the above carrier particles and a toner for forming a circuit.

In the developer for forming a wiring circuit pattern according to the present invention, an average particle size D₅₀ (t) of the toner powder for forming a circuit is preferably 3 to 150 μm, and an average particle size ratio [D₅₀ (t)/D₅₀ (c)] of the toner powder average particle size D₅₀ (t) and the carrier particle average particle size D₅₀ (c) is preferably in the range of 0.1 to 3.5.

In the developer for forming a wiring circuit pattern according to the present invention, the toner powder for forming a circuit preferably comprises as a metal powder one or more selected from the group consisting of copper powder, silver powder, nickel powder, aluminum powder, platinum powder, gold powder, tin powder, a copper alloy powder, a silver alloy powder, a nickel alloy powder, an aluminum alloy powder, a platinum alloy powder, a gold alloy powder, and a conductive oxide powder.

In the developer for forming a wiring circuit pattern according to the present invention, the toner powder for forming a circuit preferably comprises as an inorganic compound powder one or more selected from the group consisting of barium titanate, strontium titanate, calcium titanate, titanium oxide, and silica.

The carrier particles for forming a wiring circuit pattern according to the present invention have high charge properties, and yet have good charge startup properties and fluidity, because they have a carrier core material surface which is coated with an acrylic resin, and also because they are spherical. Therefore, when used along with a toner as a developer for forming a wiring circuit pattern, these carrier particles can impart a sufficient charge to the toner.

### DETAILED DESCRIPTION OF THE PREFERRED EMBODIMENTS

Preferred embodiments for carrying out the present invention will now be described.

### <Carrier Particles for Forming a Wiring Circuit Pattern According to the Present Invention>

The carrier particles for forming a wiring circuit pattern according to the present invention use any of a metal powder, an inorganic compound powder, or a mixed raw material powder thereof as the toner for forming a circuit. This toner powder for forming a circuit is adhered to the surface by electrostatic force and then transported to the surface of the insulating layer and is used for directly forming the circuit shape on the insulating layer.

The carrier core material particles used in the present invention have a shape factor SF-1 of 100 to 110, and 100 to 108 is preferred. By using such spherical carrier core material particles, concave portions on the surface are eliminated, so that the contact points with the toner, which does have indents on its surface, increase, whereby frictional charging occurs more easily. Further, the contact frequency with the toner increases, so that charge startup is also improved. If the shape factor SF-1 is more than 110, the shape is no longer spherical, so that the contact points with the toner decrease, and a sufficient charge cannot be imparted to the toner. Here, the shape factor SF-1 is determined as follows.

### (Shape Factor: SF-1)

Using a JSM-6060A manufactured by JEOL Ltd., with an accelerating voltage of 20 kV, and a carrier SEM set at a 200 times view, the particles were photographed by dispersing them so that they did not overlap each other. This image information was fed via an interface into image analyzing software (Image-Pro PLUS) produced by Media Cybernetics Inc. for analysis to determine the area (surface area) and the Fere diameter (maximum). The shape factor SF-1 was the value obtained by calculating according to the following equation. The closer the carrier shape is to a sphere, the closer the value is to 100. The shape factor SF-1 was found by performing a calculation for each particle, and taking the average value of 100 particles of the carrier.

SF-1=(R²/S)×(π/4)×100

R: Fere diameter (maximum), S: Area (surface area)

These carrier core material particles are not especially limited, but are preferably formed by a ferrite component. It is especially preferred that the ferrite component includes at least one selected from the group consisting of Mn, Mg, Li, Ca, Sr, Cu, and Zn. Considering the recent trend towards reducing environmental burden, such as restrictions on waste products, it is preferable for the heavy metals Cu, Zn, and Ni to be contained in an amount which does not exceed the scope of unavoidable impurities (accompanying impurities).

The carrier particles for forming a wiring circuit pattern according to the present invention have a resin coated layer formed using an acrylic resin composition containing an amino-group-containing polymer on the surface of the carrier core material particles. By having such a resin coated layer, the charging capability of the carrier increases, so that a carrier having a high charge and good charge startup properties can be obtained.

Specific examples of the amino-group-containing polymer include dialkylaminoalkyl (meth)acrylates having an alkyl group with 1 to 4 carbon atoms, such as dimethylaminoethyl (meth)acrylate, dimethylaminopropyl (meth)acrylate, dimethylaminobutyl (meth)acrylate, diethylaminoethyl (meth)acrylate, diethylaminopropyl (meth)acrylate, diethylaminobutyl (meth)acrylate, ethylmethylaminoethyl (meth)acrylate, ethylmethylaminopropyl (meth)acrylate, and ethylmethylaminobutyl (meth) acrylate. Further, examples of an acrylic resin containing an amino-group-containing polymer include LR-269, manufactured by Mitsubishi Rayon Co., Ltd.

Such a resin coated layer is preferably formed using a fluidized bed coater. By using a fluidized bed coater, the resin coated layer can be uniformly formed on the surface of the carrier core material particles.

The carrier particles for forming a wiring circuit pattern according to the present invention have an acrylic resin coating amount of 0.3 to 3.0% by weight, and preferably 0.3 to 2.5% by weight, based on a carrier core material weight of 100% by weight. If the acrylic resin coating amount is less than 0.3% by weight, the carrier core material cannot be uniformly coated, which can make it impossible to impart a sufficient charge to the toner. If the acrylic resin coating amount is more than 3.0% by weight, fluidity deteriorates, so that sufficient frictional charging cannot be carried out in the developing machine. This may not only result in it being impossible to impart a sufficient charge to the toner, but resistivity increases and the carrier tends to adhere to the printed portions, which become a factor in image defects such as white spots, and thus such an amount is not preferred.

Further, to control the electrical resistivity, charge amount, and charge speed of the carrier, a conductive agent can be added into the resin coated layer. Since the electrical resistivity of the conductive agent itself is low, there is a tendency for a sudden charge leak to occur if the added amount is too large. Therefore, the added amount is 0.25 to 20.0% by weight, preferably 0.5 to 15.0% by weight, and especially preferably 1.0 to 10.0% by weight, of the solid content of the resin coated layer. Examples of the conductive agent include conductive carbon, oxides such as titanium oxide and tin oxide, and various organic conductive agents.

Further, in the resin coated layer, a charge control agent can be included. Examples of the charge control agent include various charge control agents generally used for toners and various silane coupling agents. This is because, although the charging capability is sometimes reduced if the core material exposed surface area is controlled to be relatively small by formation of the coated layer, the charging capability can be controlled by adding the various charge control agents or the silane coupling agent. The charge control agents and coupling agents which may be used are not especially limited. Preferable examples of the charge control agent include a nigrosin dye, a quaternary ammonium salt, an organic metal complex and a metal-containing monoazo dye. Preferable examples of the silane coupling agent include an aminosilane coupling agent and a fluorinated silane coupling agent.

The carrier particles for forming a wiring circuit pattern according to the present invention preferably have a degree of fluidity of 20 to 60 sec/50 g, and more preferably 21 to 55 sec/50 g. If the degree of fluidity is less than 20 sec/50 g, fluidity is too high, so that when used as a developer, the developer is unbalanced in the developing device, which can cause the load on the motor rotating the magnetic-caused brushes to become too large. If the degree of fluidity is more than 60 sec/50 g, fluidity deteriorates, so that sufficient frictional charging cannot be carried out in the developing machine, which can make it impossible to impart a sufficient charge to the toner. This degree of fluidity is measured as follows.

### (Degree of Fluidity)

The degree of fluidity is measured according to JIS Z2502 (Metal Powder Fluidity Test Methods).

The carrier particles for forming a wiring circuit pattern according to the present invention preferably have an average particle size D₅₀ (c) of 20 to 200 μm, and more preferably 30 to 150 μm. If the average particle size D₅₀ (c) is less than 20 μm, the magnetic force per carrier particle is too small, so that carrier adhesion tends to occur, and is thus not preferable. If the average particle size D₅₀ (c) is more than 200 μm, the specific surface area is too small, so that the area in contact with the toner is too small, whereby it can become impossible to maintain the charge amount. The average particle size of the toner and the average particle size of the carrier will be described below. Further, this toner and carrier average particle size D₅₀ (t) and D₅₀ (c) are measured as follows.

### (Average Particle Size (Volume Average Particle Size))

The average particle size was measured by laser diffraction scattering. A Microtrac Particle Size Analyzer (Model 9320-X100) manufactured by Nikkiso Co., Ltd. was used as the apparatus. Measurement was carried out with a refractive index of 2.42, at 25±5° C., under a humidity of 55±15%. The average particle size (median diameter) as used here is the cumulative 50% particle size indicated in a volume distribution mode under sieving. Dispersion of the carrier sample was carried out using an aqueous solution of 0.2% sodium hexanemetaphosphate as the dispersion solution, by ultrasonic treatment for 1 minute with an ultrasonic homogenizer (UH-3C) manufactured by Ultrasonic Engineering Co., Ltd.

The carrier particles for forming a wiring circuit pattern according to the present invention preferably have a resistivity of 5×10⁸ Ω to 1×10¹³ Ω, and more preferably 1×10⁹ Ω to 5×10¹² Ω. If the resistivity is less than 5×10⁸ Ω, the resin coating is not sufficient, which means that the carrier core material is exposed. As a result, it may be impossible to impart a sufficient charge to the toner. If the resistivity is more than 1×10¹³ Ω, the carrier may adhere to the printed portions, and is thus not preferable. This resistivity is measured as follows.

### (Resistivity)

200 mg of a sample is weighed and inserted between non-magnetic parallel plate electrodes (10 mm×40 mm) having north and south poles facing each other with an inter-electrode interval of 1 mm. The sample is held between the electrodes by attaching a magnet (surface magnetic flux density: 1500 Gauss, surface area in contact with the magnet: 10 mm×30 mm) to the parallel plate electrodes, and a measurement voltage of 100 V is applied between the electrodes. The resistivity after 10 sec was measured by the 6517A type insulation resistivity tester manufactured by Keithley Instruments Inc.

The magnetization at 3K·1000/4π·A/m of the carrier particles for forming a wiring circuit pattern according to the present invention is preferably 50 to 96 Am²/kg, more preferably 55 to 96 Am²/kg, and most preferably 60 to 96 Am²/kg. If the magnetization at 3K·1000/4π·A/m is less than 50 Am²/kg, scattered matter magnetization deteriorates, which can become a factor in image defects caused by carrier adhesion. If the magnetization at 3K·1000/4π·A/m is more than 96 Am²/kg, the raised bristles of the magnetic-caused brush become sparse, so that unevenness in the thickness of the printed portions tends to occur. This can become a factor in the occurrence of problems such as conduction defects in the subsequent steps.

### (Magnetization)

Measurement was carried out using an integral-type B-H tracer BHU-60 (manufactured by Riken Denshi Co., Ltd.). An H coil for measuring magnetic field and a 4 πI coil for measuring magnetization were placed in between electromagnets. In this case, the sample was put in the 4 πI coil. The outputs of the H coil and the 4 πI coil when the magnetic field H was changed by changing the current of the electromagnets were each integrated; and with the H output as the X-axis and the 4 πI coil output as the Y-axis, a hysteresis loop was drawn on recording paper. The measuring conditions were a sample filling quantity of about 1 g, the sample filling cell had an inner diameter of 7 mm±0.02 mm and a height of 10 mm ±0.1 mm, and the 4 πI coil had a winding number of 30.

### <Method for Producing the Carrier for Forming a Wiring Circuit Pattern According to the Present Invention>

Next, the method for producing the carrier for forming a wiring circuit pattern according to the present invention will be described.

First, to obtain a given composition, a suitable amount of the ferrite raw materials are weighed, and then crushed and mixed by a ball mill, vibration mill or the like for 0.5 hours or more, and preferably for 1 to 20 hours. The resultant crushed material is pelletized by a pressure molding machine or the like, and calcined at a temperature of 900 to 1,200° C. If the calcining temperature is less than 900° C., the shape of the carrier surface after sintering becomes bumpy, while if the calcining temperature is more than 1,200° C., the crushing is difficult. This may also be carried out without using a pressure molding machine, by after the crushing adding water to form a slurry, and then granulating using a spray drier.

The calcined material is further crushed by a ball mill, vibration mill or the like, and then charged with an appropriate amount of water, and optionally with a dispersant, a binder or the like to form a slurry. After viscosity has been adjusted, the slurry is granulated using a spray drier. The resultant granules are held at a temperature of 1,100 to 1,450° C. for 1 to 24 hours while the oxygen concentration is controlled at 0 to 21% by volume to carry out sintering. In the case of crushing after calcination, the calcined material may be charged with water and crushed by a wet ball mill, wet vibration mill or the like.

The sintered material obtained by sintering in this manner is crushed and classified. The carrier core material particles are obtained by adjusting the particles to a desired size using a conventionally-known classification method, such as air classification, mesh filtration and precipitation.

Examples of a method for obtaining core material particles having a high degree of sphericity include passing the core material particles obtained by the above-described steps or a pre-sintering granule product through a flame formed from a mixed gas of oxygen and propane. To form a uniform resin coated layer from the core material particles, it is preferred to carry out a spheroidization treatment.

The surface may then optionally be subjected to an oxide film treatment by heating at a low temperature to adjust the electrical resistivity. The oxide film treatment is carried out by heat treating at, for example, 300 to 700° C., using a common rotary electric furnace, a batch electric furnace and the like. The thickness of the oxide film formed by this treatment is preferably 0.1 to 5 μm. If the thickness is less than 0.1 μm, the effects of the oxide film are small, and if the thickness is more than 5 μm, magnetization deteriorates and the resistivity becomes too high, so that drawbacks such as a deterioration in the developing ability tend to occur. Further, optionally, reduction may be carried out before the oxide film treatment.

Next, the resin coated layer is formed on the surface of the obtained carrier core material particles. A typical acrylic resin coating method is to dilute an acrylic resin (coating composition) in a solvent, and coat onto the surface of the carrier core material particles. The coating amount of the acrylic resin is as described above. Here, examples of the solvent which can be used include toluene, xylene, cellosolve butyl acetate, methyl ethyl ketone, methyl isobutyl ketone, methanol and the like. Further, a conventionally-known method may be used to coat the coated resin such as that described above onto the carrier core material particles. Examples of such coating methods include brush coating, dry method, spray-dry method using a fluidized bed, rotary-dry method and liquid immersion-dry method using a universal stirrer. To improve the coating efficiency, and to obtain a uniform coated layer, a method using a fluidized bed coater is preferable. Most preferable is to coat the resin using a fluidized bed coater on spherical carrier core material particles.

After the carrier core material particles have been coated with an acrylic resin, baking may be carried out by either external heating or internal heating. The baking can be carried out using, for example, a fixed-type or flow-type electric furnace, rotary electric furnace, burner furnace, or even by using microwaves.

The carrier particles according to the present invention are thus obtained by coating the resin on the surface of the carrier core material particles, and then baking, cooling, crushing, and carrying out particle size adjustment.

### <Developer for Forming a Wiring Circuit Pattern According to the Present Invention>

Next, the developer for forming a wiring circuit pattern according to the present invention will be described.

The developer for forming a wiring circuit pattern according to the present invention is composed of the above-described carrier particles and a toner powder for forming a circuit.

The toner powder constituting the developer for forming a wiring circuit pattern of the present invention preferably has an average particle size D₅₀ (t) of 3 to 150 μm. If the toner powder average particle size D₅₀ (t) is beyond this range, electrostatic control becomes difficult, so that ground fogging and the like occur, whereby the image level deteriorates. Further, if the toner powder average particle size D₅₀ (t) is more than 150 μm, a fine wiring circuit cannot be formed.

The developer for forming a wiring circuit pattern of the present invention preferably has an average particle size ratio [D₅₀ (t)/D₅₀ (c)] of the toner powder average particle size D₅₀ (t) and the carrier particle average particle size D₅₀ (c) in the range 0.1 to 3.5, more preferably 0.1 to 0.9 and 1.1 to 3.5, and most preferably 0.1 to 0.8 and 1.2 to 3.5. If the average particle size ratio is less than 0.1, a sufficient printing thickness cannot be obtained with one print, and thus the developer cannot be used for wiring substrate applications. If the average particle size ratio is more than 3.5, the carrier is too small compared with the toner, so that it may be impossible to impart a sufficient charge to the toner.

This toner powder for forming a wiring circuit pattern may be any of a metal powder, an inorganic compound powder, or a mixed raw material powder thereof. Examples of metal powders which can be used as this toner powder for forming a wiring circuit pattern include one or more selected from the group consisting of copper powder, silver powder, nickel powder, aluminum powder, platinum powder, gold powder, tin powder, a copper alloy powder, a silver alloy powder, a nickel alloy powder, an aluminum alloy powder, a platinum alloy powder, a gold alloy powder, and a conductive oxide powder. A metal powder may be used which has a surface coated with an insulating resin such as polyethylene, and a surface treating agent such as a saturated fatty acid, an unsaturated fatty acid, and various silane coupling agents.

Examples of inorganic compound powders which can be used as the toner powder for forming a wiring circuit pattern include one or more obtained from the group consisting of barium titanate, strontium titanate, calcium titanate, titanium oxide, and silica. An inorganic compound powder may be used which has a surface coated with an insulating resin such as polyethylene, and a surface treating agent such as a saturated fatty acid, an unsaturated fatty acid, and various silane coupling agents.

The method for producing the toner may be either a crushing method or a polymerization method. Regarding the binder resin, various binder resins may be selected according to the method of treating after printing on the target object and the application of the printing target. Concerning the various additives, such as a charge control agent, which are included in the toner, although various additives may also be selected according to the method of treating after printing on the target object and the application of the printing target, needless to say the additives and binder must not ultimately have an adverse affect on the performance, including safety etc., of the resultant product.

The mixing ratio of the carrier particles and the toner powder in the developer for forming a wiring circuit pattern of the present invention, specifically, the toner concentration, is preferably set at 5 to 30% by weight. If the ratio is less than 5% by weight, it is difficult to obtain the desired image density, and if the ratio is more than 30% by weight, toner scattering and fogging tend to occur.

The developer for forming a wiring circuit pattern according to the present invention may be used for a wiring pattern of various electronic device substrates, various wiring patterns on a flat panel display substrate, and/or wiring formation of an inner layer electrode, etc. in a layered electronic part such as a layered ceramic capacitor.

The present invention will now be described in more detail based on the following examples.

### EXAMPLE 1

A suitable amount of the respective raw materials was weighed out and blended so that the resultant mixture was 39.7 mol % in terms of MnO, 9.9 mol % in terms of MgO, 49.6 mol % in terms of Fe₂O3, and 0.8 mol % in terms of SrO. The mixture was charged with water, and the resultant slurry was crushed and mixed for 10 hours with a wet ball mill, and then dried. The mixture was held for 4 hours at 950° C., and then crushed for 24 hours with a wet ball mill. The resultant slurry was then granulated and dried. The resultant granules were held for 6 hours at 1,270° C. in an atmosphere having an oxygen concentration of 0%, then crushed, and adjusted for particle size to obtain Mn—Mg—Sr ferrite particles (carrier core material particles).

The obtained ferrite particles were subjected to a spheroidization treatment by passing at a supply rate of 40 kg/hr through a flame supplied with 5 Nm³/hr of propane and 25 Nm³/hr of oxygen. The obtained ferrite particles were, as shown in Table 1, spherical, and had an average particle size D₅₀ of approximately 80 μm and a shape factor SF-1 of 108.

Next, an acrylic resin composition containing an amino-group-containing polymer (trade name: LR-269, manufactured by Mitsubishi Rayon Co., Ltd.) was diluted with water to prepare a solution for forming the coated layer. This solution for forming the coated layer and 10 kg of the carrier core material particles were together charged into a fluidized bed coater to form a resin coated layer. Then, the particles were baked for 1 hour at 145° C. to produce carrier particles for forming a wiring circuit pattern having a 0.5% by weight resin coating amount.

### EXAMPLE 2

Carrier particles for forming a wiring circuit pattern were produced in the same manner as in Example 1, except that the acrylic resin coating amount was 0.3% by weight.

### EXAMPLE 3

Carrier particles for forming a wiring circuit pattern were produced in the same manner as in Example 1, except that the acrylic resin coating amount was 2.5% by weight.

### EXAMPLE 4

Carrier particles for forming a wiring circuit pattern were produced in the same manner as in Example 1, except that carrier core material particles having an average particle size D₅₀ of approximately 35 μm and a shape factor SF-1 of 106 were prepared.

### EXAMPLE 5

Carrier particles for forming a wiring circuit pattern were produced in the same manner as in Example 1, except that the carrier core material composition was 20 mol % in terms of MnO and 80 mol % in terms of Fe₂O₃, and carrier core material particles having an average particle size D₅₀ of approximately 120 μm and a shape factor SF-1 of 109 were prepared.

### EXAMPLE 6

Carrier particles for forming a wiring circuit pattern were produced in the same manner as in Example 1, except that a mixture of an amino silane coupling agent (trade name: AY43-059, manufactured by Dow Corning Toray Co., Ltd.) added to the acrylic resin composition LR-269 containing an amino-group-containing polymer was used as the acrylic resin composition for coating the core material particles. Here, the amino silane coupling agent at this stage was added so as to be 10% by weight based on the solid content of the acrylic resin composition.

### COMPARATIVE EXAMPLE 1

Carrier particles for forming a wiring circuit pattern were produced in the same manner as in Example 1, except that carrier core material particles having an average particle size D₅₀ of approximately 80 μm and a shape factor SF-1 of 121 which had not been subjected to a spheroidization treatment were prepared.

### COMPARATIVE EXAMPLE 2

Carrier particles for forming a wiring circuit pattern were produced in the same manner as in Example 1, except that an acrylic resin (trade name: BR-52, manufactured by Mitsubishi Rayon Co., Ltd.) was used instead of the acrylic resin composition LR-269 containing an amino-group-containing polymer.

### COMPARATIVE EXAMPLE 3

Carrier particles for forming a wiring circuit pattern were produced in the same manner as in Example 1, except that the acrylic resin coating amount was 3.5% by weight.

### COMPARATIVE EXAMPLE 4

Carrier particles for forming a wiring circuit pattern were produced in the same manner as in Example 1, except that the acrylic resin coating amount was 0.25% by weight.

### COMPARATIVE EXAMPLE 5

Carrier particles for forming a wiring circuit pattern were produced in the same manner as in Example 1, except that a silicone resin (trade name: SR2411, manufactured by Dow Corning Toray Co., Ltd.) was used instead of the acrylic resin composition LR-269 containing an amino-group-containing polymer.

Table 1 shows the properties (average particle size, shape, and shape factor SF-1) and the resin coating conditions (apparatus, resin name, and coating amount) of the carrier core material particles of the carrier particles for forming a wiring circuit pattern of the thus-produced Examples 1 to 6 and Comparative Examples 1 to 5. Further, Table 2 shows the properties (average particle size D₅₀ (c), degree of fluidity, resistivity, and magnetization) of the carrier particles for forming a wiring circuit pattern. Table 3 shows the developer properties (charge amount). The average particle size, degree of fluidity, resistivity, and magnetization were measured according to the methods described above. Further, the charge amount was measured according to the following method.

(Charge Amount Measurement (when 0.1≦D₅₀ (t)/D₅₀ (c)≦1))

5 g of negatively-charged nickel powder toner for evaluation having an average particle size D₅₀ (t) of 15 μm and 45 g of the carrier were weighed and charged into a 50 cc glass bottle. The resultant mixture was then mixed and stirred with a ball mill while matching the rotation number of the glass bottle to 100 revolutions. 0.5 g of the developer was sampled respectively 1 minute, 5 minutes, and 30 minutes after the start of stirring to measure the charge amount with a self-made electrolytic parting type charge amount measurement apparatus which used magnetic-caused brushes. The charge amount per 1 g of toner was calculated from the amount of toner which moved to the electrodes and the cumulative charge amount at that time, with a rotation number of the magnetic-caused brushes at this stage of 200 rpm, a distance between the magnetic-caused brushes and the electrodes of 4 mm, an applied voltage of 2,000 V, and a measurement time of 1 minute. The charge amount for when negatively-charged nickel powder toner for evaluation having an average particle size D₅₀ (t) of 25 μm was used was measured in the same manner, except that 3 g of negatively-charged nickel powder toner for evaluation and 47 g of carrier were used.

(Charge Amount Measurement (when 1<D₅₀ (t)/D₅₀ (c)≦3.5))

2 g of negatively-charged nickel powder toner for evaluation having an average particle size D₅₀ (t) of 120 μm and 48 g of the carrier were weighed and charged into a 50 cc glass bottle. The resultant mixture was then mixed and stirred with a ball mill while matching the rotation number of the glass bottle to 100 revolutions. 0.5 g of the developer was sampled respectively 1 minute, 5 minutes, and 30 minutes after the start of stirring to measure the charge amount with a blow-off charge amount measurement apparatus (manufactured by Toshiba Chemical Corporation, TB-200). At this stage, the charge amount per 1 g of toner was calculated from the amount of toner which was removed from the Coulomb cage by blowing and the charge amount measured at that time, with a 250 mesh used as the blow mesh, a 0.1 kg/cm² blow pressure, and a 60 second measurement time. The charge amount for when negatively-charged nickel powder toner for evaluation having an average particle size D₅₀ (t) of 60 μm was used was measured in the same manner, except that 4 g of negatively-charged nickel powder toner for evaluation and 46 g of carrier were used.

### (Production of the Toners for Evaluation)

The toners for evaluation were produced by mixing with a Henschel mixer 4 kg of an acrylic binder resin, 1 kg of particles as a filler obtained by coating the surface of a nickel powder having an average particle size of 0.6 μm obtained by wet reduction with a silane coupling agent, and 100 g of a negatively-charged charge control agent. The mixture was melt-kneaded by a kneader, and the resultant mixture was coarsely crushed by a Henschel mixer and a hammer mill. The mixture was then finely crushed by a jet mill. The resultant crushed material was classified using an air classifier so that the average particle size D₅₀ (t) was 15 μm, and this material was used as the toner for evaluation when 0.1≦D₅₀ (t)/D₅₀ (c)≦1. Further, a toner for evaluation having an average particle size D₅₀ (t) of 25 μm was obtained in the same manner. In addition, toners were also obtained in the same manner having an average particle size D₅₀ (t) of 60 μm and 120 μm as the toner for evaluation when 1<D₅₀ (t)/D₅₀ (c)≦3.5.

TABLE 1

| | Carrier Core Material Particles | | | | Resin Coating | | | |
|---|---|---|---|---|---|---|---|---|
| | | Average | | | | | Presence | |
| | | Particle | | | | | of Amino-Group- | Coat |
| | | Size | | Shape Factor | | | Containing | Amount |
| | Composition | (um) | Shape | SF-1 | Apparatus | Resin Name | Polymer | (wt %) |
| Example 1 | Mn—Mg—Sr Ferrite | 80 | Spherical | 108 | Fluidized Bed Coater | LR-269 | Yes | 0.5 |
| Example 2 | Mn—Mg—Sr Ferrite | 80 | Spherical | 108 | Fluidized Bed Coater | LR-269 | Yes | 0.3 |
| Example 3 | Mn—Mg—Sr Ferrite | 80 | Spherical | 108 | Fluidized Bed Coater | LR-269 | Yes | 2.5 |
| Example 4 | Mn—Mg—Sr Ferrite | 35 | Spherical | 106 | Fluidized Bed Coater | LR-269 | Yes | 2.5 |
| Example 5 | Mn Ferrite | 120 | Spherical | 109 | Fluidized Bed Coater | LR-269 | Yes | 0.5 |
| Example 6 | Mn—Mg—Sr Ferrite | 80 | Spherical | 108 | Fluidized Bed Coater | LR-269 + AY43-059 | Yes | 0.5 |
| Comparative | Mn—Mg—Sr Ferrite | 80 | Normal | 121 | Fluidized Bed Coater | LR-269 | Yes | 0.5 |
| Example 1 | | | | | | | | |
| Comparative | Mn—Mg—Sr Ferrite | 80 | Spherical | 108 | Fluidized Bed Coater | BR-52 | No | 0.5 |
| Example 2 | | | | | | | | |
| Comparative | Mn—Mg—Sr Ferrite | 80 | Spherical | 108 | Fluidized Bed Coater | LR-269 | Yes | 3.5 |
| Example 3 | | | | | | | | |
| Comparative | Mn—Mg—Sr Ferrite | 80 | Spherical | 108 | Fluidized Bed Coater | LR-269 | Yes | 0.25 |
| Example 4 | | | | | | | | |
| Comparative | Mn—Mg—Sr Ferrite | 80 | Spherical | 108 | Fluidized Bed Coater | SR-2411 | No | 0.5 |
| Example 5 | | | | | | | | |

TABLE 2

| | Carrier Properties | | | |
|---|---|---|---|---|
| | Average | Degree of | | |
| | Particle Size | Fluidity | | Magnetization |
| | (um) | (sec/50 g) | Resistivity (Ω) | (Am²/Kg) |
| Example 1 | 81.69 | 27.6 | 5.1 × 10¹⁰ | 73 |
| Example 2 | 80.54 | 22.5 | 1.2 × 10⁹ | 73 |
| Example 3 | 84.32 | 33.5 | 4.3 × 10¹² | 71 |
| Example 4 | 35.84 | 54.3 | 9.4 × 10¹¹ | 71 |
| Example 5 | 121.37 | 23.1 | 1.9 × 10¹¹ | 95 |
| Example 6 | 80.72 | 27.3 | 3.8 × 10¹⁰ | 72 |
| Comparative | 81.06 | None | 4.1 × 10⁸ | 65 |
| Example 1 | | | | |
| Comparative | 82.44 | 27.7 | 5.1 × 10¹⁰ | 72 |
| Example 2 | | | | |
| Comparative | 85.1 | None | 1.8 × 10¹³ | 70 |
| Example 3 | | | | |
| Comparative | 80.44 | 19.7 | 2.1 × 10⁸ | 73 |
| Example 4 | | | | |
| Comparative | 80.87 | 30.8 | 7.2 × 10¹⁰ | 72 |
| Example 5 | | | | |

TABLE 3
Developer Properties (Charge Amount μC/g))

| | Used Toner | | | | | | | | | | | | | | | |
|---|---|---|---|---|---|---|---|---|---|---|---|---|---|---|---|---|
| | | | | Ratio of | | | | Ratio of | | | | Ratio of | | | | Ratio of |
| | | | | Carrier | | | | Carrier | | | | Carrier | | | | Carrier |
| | | | | and | | | | and | | | | and | | | | and |
| | | | | Toner | | | | Toner | | | | Toner | | | | Toner |
| | Average Particle | | | Particle | Average Particle | | | Particle | Average Particle Size | | | Particle | Average Particle | | | Particle |
| | Size D₅₀(t) = 15 μm | | | Sizes | Size D₅₀(t) = 25 μm | | | Sizes | D₅₀(t) = 60 μm | | | Sizes | Size D₅₀(t) = 120 μm | | | Sizes |
| | Stirring Time | | | | | | | | | | | | | | | |
| | | | | D₅₀(t)/ | | | | D₅₀(t) | | | | D₅₀(t)/ | | | | D₅₀(t)/ |
| | 1 min | 5 min | 30 min | D₅₀(c) | 1 min | 5 min | 30 min | D₅₀(c) | 1 min | 5 min | 30 min | D₅₀(c) | 1 min | 5 min | 30 min | D₅₀(c) |
| Example 1 | 5.63 | 6.22 | 7.37 | 0.18 | 5.44 | 6.01 | 6.88 | 0.31 | — | — | — | — | — | — | — | — |
| Example 2 | 4.08 | 4.63 | 5.68 | 0.19 | 4 | 4.47 | 5.23 | 0.31 | — | — | — | — | — | — | — | — |
| Example 3 | 7.38 | 7.65 | 9.32 | 0.18 | 6.76 | 6.87 | 8.76 | 0.30 | — | — | — | — | — | — | — | — |
| Example 4 | — | — | — | — | — | — | — | — | 7.04 | 9.12 | 10.86 | 1.67 | 6.75 | 8.40 | 10.42 | 3.35 |
| Example 5 | 6.57 | 7.63 | 8.85 | 0.12 | 6.11 | 7.23 | 8.43 | 0.21 | — | — | — | — | — | — | — | — |
| Example 6 | 8.40 | 9.13 | 10.92 | 0.19 | 8.12 | 8.89 | 10.45 | 0.31 | — | — | — | — | — | — | — | — |
| Comparative | 2.93 | 3.87 | 4.45 | 0.19 | 2.41 | 3.21 | 3.97 | 0.31 | — | — | — | — | — | — | — | — |
| Example 1 | | | | | | | | | | | | | | | | |
| Comparative | 1.42 | 1.68 | 2.02 | 0.18 | 1.22 | 1.45 | 1.89 | 0.30 | — | — | — | — | — | — | — | — |
| Example 2 | | | | | | | | | | | | | | | | |
| Comparative | 7.77 | 7.85 | 9.35 | 0.18 | 7.12 | 7.33 | 8.91 | 0.29 | — | — | — | — | — | — | — | — |
| Example 3 | | | | | | | | | | | | | | | | |
| Comparative | 2.02 | 2.68 | 3.08 | 0.19 | 1.65 | 2.43 | 2.76 | 0.31 | — | — | — | — | — | — | — | — |
| Example 4 | | | | | | | | | | | | | | | | |
| Comparative | 0.57 | 0.72 | 0.80 | 0.19 | 0.31 | 0.51 | 0.65 | 0.31 | — | — | — | — | — | — | — | — |
| Example 5 | | | | | | | | | | | | | | | | |

As shown in Tables 1 to 3, it was confirmed that the carrier particles described in Examples 1 to 6 have sufficient charging capability, resistivity, and fluidity to be used as a developer for a wiring substrate. As the charge amount of the developer, charge startup is important in terms of preventing toner scattering during formation of the circuit wiring. While it can depend on the evaluation conditions, generally it is preferred for the charge amount in 1 minute to be 4 μC/g or more. On the other hand, in Comparative Examples 1 and 4, the core material surface was exposed, and a sufficient charge could not be obtained. In Comparative Example 2, since an amino-group-containing polymer was not included, sufficient charging capability was not obtained. In Comparative Examples 1 and 3, fluidity was poor. In Comparative Example 5, since the kind of resin was different, sufficient charging capability was not obtained.

The carrier particles for forming a wiring circuit pattern according to the present invention have a high charge and good charge startup properties, due to the carrier core material surface being coated with an acrylic resin, and the spherical shape of the carrier particles. Therefore, sufficient charge can be imparted to a toner when these carrier particles are used with a toner to form a developer. Therefore, the developer according to the present invention can be suitably used for forming a wiring circuit pattern.

1. Carrier particles for forming a wiring circuit pattern by an electrophotographic developing method which are used for directly forming a circuit shape on an insulating layer, with any of a metal powder, an inorganic compound powder, or a mixed raw material powder thereof used as a toner powder for forming a circuit, the toner powder for forming a circuit being adhered to a surface of the carrier particles by electrostatic force and then transported to a surface of the insulating layer,
wherein the carrier particles comprise a coated layer of an acrylic resin composition containing an amino-group-containing polymer on the surface of the carrier core material particles, the coating amount of the acrylic resin composition is 0.3 to 3.0% by weight based on a carrier core material weight of 100% by weight, and a shape factor SF-1 of the carrier core material particles is 100 to 110.

2. The carrier particles for forming a wiring circuit pattern according to claim 1, wherein the carrier particles have a degree of fluidity of 20 to 60 sec/50 g.

3. The carrier particles for forming a wiring circuit pattern according to claim 1, wherein the carrier core material particles are formed from a ferrite component.

4. The carrier particles for forming a wiring circuit pattern according to claim 1, wherein the carrier particles have an average particle size D₅₀ (c) of 20 to 200 μm.

5. The carrier particles for forming a wiring circuit pattern according to claim 1, wherein the carrier particles have a resistivity of 5×10⁸ Ω to 1×10¹³ Ω.

6. The carrier particles for forming a wiring circuit pattern according to claim 1, wherein the coated layer is formed by a fluidized bed coater.

7. A developer for forming a wiring circuit pattern by an electrophotographic developing method, comprising the carrier particles according to claim 1, and a toner powder for forming a circuit.

8. The developer for forming a wiring circuit pattern according to claim 7, wherein an average particle size D₅₀ (t) of the toner powder for forming a circuit is 3 to 150 μm, and an average particle size ratio [D₅₀ (t)/D₅₀ (c)] of the toner powder average particle size D₅₀ (t) and the carrier particle average particle size D₅₀ (c) is in the range of 0.1 to 3.5.

9. The developer for forming a wiring circuit pattern according to claim 7, wherein the toner powder for forming a circuit comprises as a metal powder one or more selected from the group consisting of copper powder, silver powder, nickel powder, aluminum powder, platinum powder, gold powder, tin powder, a copper alloy powder, a silver alloy powder, a nickel alloy powder, an aluminum alloy powder, a platinum alloy powder, a gold alloy powder, and a conductive oxide powder.

10. The developer for forming a wiring circuit pattern according to claim 7, wherein the toner powder for forming a circuit comprises as an inorganic compound powder one or more selected from the group consisting of barium titanate, strontium titanate, calcium titanate, titanium oxide, and silica.
